(19) United States
(12) Patent Application Publication
(10) Pub. No.: US 2011/0157730 A1
(43) Pub. Date: Jun. 30, 2011

(54) PERIPHERAL VISION AMPLIFYING POSTERIOR, LATERAL, EXTERNAL REAR-VIEW MIRROR (BACK-UP MIRROR) FOR AUTOMOBILE VEHICLES

(76) Inventor: MICHAEL HEATH LEWIS, Cedar Hill, TX (US)

(21) Appl. No.: 12/649,473

(22) Filed: Dec. 30, 2009

(51) Int. Cl. G02B 5/08

(52) U.S. Cl. 359/843

(57) ABSTRACT

A peripheral vision amplifying posterior, lateral, external rear-view mirror (back-up minor system 100) for automobile vehicles typically located on the rear quarter panels of automobile vehicles that allows automobile operators to see an image of approaching objects, including, but not limited to, pedestrians and other approaching car(s) 30 approaching the automobile vehicle 10 perpendicular or normal to the automobile vehicle 10 sides and to prevent a collision with said approaching car(s) 30 by viewing their image in the adjustable back-up minor assembly via a conventional rear-view minor 11 and 12 located on the sides of the automobile vehicle 10.

### CROSS-REFERENCE TO RELATED APPLICATIONS

NOT APPLICABLE

### FEDERALLY SPONSORED SEARCH

NOT APPLICABLE

### SEQUENCE LISTING

NOT APPLICABLE

### FIELD OF THE INVENTION

This relates to automotive rear-view minors, specifically to posterior, lateral, external rear-view mirrors having means that allow automobile operators to increase their peripheral vision and field of view at the rear of their automobiles while in backing their automobiles out of parking spaces where their vision is obstructed by automobiles or obstacles adjacent to their own.

### BACKGROUND

Pulling a car out of a parking space can be a dangerous activity and must be done with great care. Automobiles or obstacle adjacent to the automobile being pulled out of a parking space prevent the driver from seeing approaching cars, people or approaching obstacles while in the process of reversing. Conventional external rear-view mirrors provide the driver with an image of obstacles directly behind the user automobile and a limited peripheral or tangential view of approaching automobiles, people or moving obstacles. The internal rear-view minor is even more limited in its capacity to provide an amplified peripheral view of approaching automobiles, pedestrians, or moving obstacles. Everyday hundreds of accidents occur as a result of automobiles backing out of parking spaces striking approaching objects. The field of the present invention is an automobile safety improvement device for aiding drivers of passenger vehicles driving in reverse.

When a driver of a parked passenger vehicle backs out of a parking space into a lane (or lanes) of cross-traffic, such as in a parking lot, the driver avoids collisions by looking for nearby oncoming cross-traffic before backing up. Views of the oncoming cross-traffic are frequently blocked when a large or tall vehicle is parked in an adjacent parking space, creating a safety problem. The frequency of such blockage has increased dramatically since the mid-1980's due to the popularity of taller passenger vehicles such as mini-vans and Sport Utility Vehicles (SUVs), while in prior years, an adjacent parked vehicle was frequently a sedan-type passenger vehicle whose trunk height was generally not higher than the driver's eye level.

Another safety problem arises during backing up when the direct, unaided, view towards oncoming cross-traffic lane(s) are beyond the peripheral vision of a driver's unaided eye, such as with drivers whose body has limited flexibility or limited range of motion in the neck and/or torso, and therefore cannot turn their head and/or torso far enough towards the rear of the vehicle when backing up to directly view the lane(s) of oncoming cross-traffic, such as is the case for many senior citizens.

While the use of a minor or a minor system for improving a driver's view of nearby traffic conditions is prolific in prior art, and familiar, with largely expected configurations, the problem of a driver's backing up their passenger vehicle, in reverse, without sufficient visibility of any nearby oncoming cross-traffic in lane(s) passing behind the vehicle has not been sufficiently addressed by prior art designs which were developed to fulfill other visibility objectives.

Prior to the present invention, drivers backing their passenger vehicle out of an obstructed-view parking space, garage, or fenced area must simply back out slowly enough for oncoming cross-traffic to respond in one of the following ways: a.) yielding to the backing-out vehicle, b.) honking to signal that the backing-up driver should stop backing-up, c.) swerving away from the backing-up vehicle while passing behind it, or d.) colliding with the backing-up vehicle. The US National Highway Traffic Safety Administration found that back-up collisions most often:
occur in residential driveways and parking lots
involve sport utility vehicles (SUVs) or small trucks
occur when a parent, relative or someone known to the family is driving
particularly affect children less than five years old

The driver of the car backing up and hitting an object, a person, or another car is usually considered to be at fault. Furthermore, safer backing up is done when the driver turns completely around and looks out of the rear window of the car, rather than relying on minors. This provides a wider field of vision and better control of the vehicle. Hundreds of driver-education courses include a unit on safety tactics for backing up, and several educational videos are currently for sale on the backing-up-safely issue. The 2001 California Driver Handbook of Safe Driving Practices instructs a driver to get out of the vehicle to look before backing up. This method doesn't solve the problem entirely because new oncoming cross-traffic could easily arrive during the 4 or 5 seconds that elapse while the driver gets back into the vehicle, fastens the seatbelt, and puts the transmission in reverse, and the driver would still have restricted visibility of that oncoming cross-traffic lane while seated in the driver's seat. Other driver training manuals offer their road-sense tip advising a driver to honk a warning tap on their horn if visibility is limited when starting to back up. This does not necessarily successfully alert the oncoming cross-traffic vehicle(s) of the imminent lane blockage, nor does it provide the backing-up driver with visibility of the oncoming cross-traffic lane(s) when seated in the driver's seat.

There are numerous electronic collision avoidance systems (CAS) in prior art which address regions outside the vehicle for detecting the presence of traffic in parallel lanes of travel (highway blind spot regions), or for detecting and warning of objects directly behind the vehicle's rear bumper. These systems, using radar, microwave, video camera, etc. technologies, draw power from on board their vehicle, constituting non-passive (active) methods of improving safety. The disadvantage of these designs is that they do not provide the driver with a view of the region(s) to the side of the rear bumper, namely where any nearby oncoming cross-traffic approaches to flow behind the vehicle which is about to back up, in a passive (non-powered) method. Further disadvantages are the difficulty of installing the numerous CAS components on previously-manufactured vehicles, the relatively expensive array of electronic components that comprise a CAS, and the complexity of assembling numerous electronic sensors and mechanical components to accomplish the detection and warning system, and the susceptibility to electronic component failure which leads to a less robust system life.

Some vehicles have a standard-equipment system which emanates a warning beeping tone which sounds repeatedly when the transmission is in reverse. This warning beep system does not provide a driver with better visibility of any nearby oncoming cross-traffic imminently passing behind the driver's vehicle, it merely attempts to warn oncoming cross-traffic of an imminent lane blockage.

U.S. Pat. No. 2,783,683 (1957) Maurer relates to a “device for providing the driver of an automobile with a clear view in both directions of the street he is about to enter”. This device is designed to assist the driver while traveling in the forward direction and is located in the midline of the vehicle. This device does not assist the driver in increasing the posterior, lateral, peripheral view while in reverse. The device in U.S. Pat. No. 2,783,683 is also located on the anterior, midline hood of the vehicle and thereby cannot provide a view of approaching vehicles from the rear. This invention is not designed to operate on the posterior, lateral, external section (rear quarter panel) of the automobile vehicle.

U.S. Pat. No. 5,424,875 (1995) to Davis, II “relates to the field of mirrors for motor vehicles, for example, mirrors that alert motorists to traffic that is approaching from various angles, e.g., from the side street”. This patent “generally features a mirror arrangement for mounting on a motor vehicle having a passenger compartment, the minor arrangement including: a polygon three dimensional member having at least two planar surfaces oriented obliquely with respect to one another at an apex.” A coaxial cable is used to rotate the mirror from inside the passenger compartment of the motor vehicle. This invention is not attached to the posterior, lateral, external section (rear quarter panel) of the motor vehicle, but rather an area between the sides of the vehicle. This invention is also prismatic and does not articulate or rotate or articulate at its apex. This invention is not designed to operate on the posterior, lateral, external section (rear quarter panel) of the automobile vehicle.

U.S. Pat. No. 6,715,893 (2004) to Martinson “relates generally to minors for vehicles designed to aid a driver in identifying objects, and more specifically, to a trunk-mounted lateral view mirror assembly for a vehicle dimensioned to allow a driver to view objects positioned lateral to a rear portion of the vehicle”. The limitation of this patent is that it is mounted on the trunk of the vehicle and not the posterior, lateral, external section (rear quarter panel) of the vehicle. This limits the applicability to many vehicles in that the trunk designs are quite vast. The marketability of this invention is quite limited. Finally, this invention is prismatic and does not rotate at an apex. This invention is not designed to operate on the posterior, lateral, external section (rear quarter panel) of the automobile vehicle.

U.S. Pat. No. 6,871,971 (2001) to Morrison relates to “the field of this present invention is an automobile safety improvement for aiding drivers of passenger vehicles driving in reverse”. Morrison states, “the back-up mirror, located in a position generally aft of the driver's seat whose reflective surface is generally facing towards one side of the vehicle (left-looking or right-looking). In this invention, as illustrated in Morrison FIG. 1, the mirror is located inside passenger compartment of the vehicle and not on the, posterior, lateral, external section (rear quarter panel) of the vehicle. The view in this minor could be impaired if the rear-view windshield is fogged, cracked, tinted or if there are passengers in the back seat. Because the mirror is not permanently mounted to the interior of the passenger compartment by the manufacturer, the minor could become a projectile within the passenger compartment in event of a collision. The marketability of this invention is limited for these reasons. This invention is not designed to operate on the posterior, lateral, external section (rear quarter panel) of the automobile vehicle.

U.S. Pat. No. 5,666,227 (1997) to Ben Ghiath “relates to the devices, assemblies and systems for affording panoramic forward, side, rear and underneath panoramic views for a wide range of transportation means including private vehicles, full trailers, semi-trailers, buses, aircraft, ships and the alike. None of Ben Ghiath's aspects provide a mirror that increases the posterior peripheral view where the device is located on the posterior, lateral, external section (rear quarter panel) of automobile that is adjustable by the user from 0 to 180 degrees. Ben Ghiath does not specify how the minor is to be attached to the automobile. According to the figures in this patent the minor are in space with not apparent attachment apparatus or adhesive. Ben Ghiath is not specific in how the minor will be fastened to the automobiles. Ben Ghiath suggests that in FIGS. 3A, 3B, and 3C these mirrors will levitate about the automobile vehicle, which has not yet been proven scientifically that objects with mass can levitate in space near the Earth's surface without an external force supporting them such as the Earth itself. These mirrors will succumb to the Earth gravitational pull, fall to the ground and break. With the minors broken they will be useless. Ben Ghiath FIG. 1D illustrates a minor positioned in the midline of the automobile vehicle with the purpose of increasing the driver's side views. However, Ben Ghiath does not specify how this minor is attached and the minor will succumb to gravity and fall off of the vehicle at the time the driver accelerates. In addition, Ben Ghiath FIG. 1D illustrates the minor attached at the midline of the vehicle and not the posterior, lateral, external section (rear quarter panel) of the automobile vehicle. Finally, Ben Ghiath's invention is prismatic or shaped like a prism. This device has the geometric configuration of a prism as illustrated in Ben Ghiath FIG. 1D. The other embodiments are flat minors with no apparent method of attachment or axis or rotation, if any.

U.S. patent application No. 20020186481 (2002) to Martinson “relates generally to mirrors for vehicles designed to aid a driver in identifying objects, and more specifically, to a lateral-view mirror, for a vehicle dimensioned to allow a driver to view object positioned lateral to a rear portion of the vehicle”. FIG. 1 illustrates a prismatic device attached to the flank of a vehicle. This device does not articulate at the prism's apex. The prismatic device articulates at its base and not its apex. This invention illustrates in FIG. 12 the method of attachment to the vehicle is a vertical articulating base attached to the trunk of the vehicle and not the posterior, lateral, external section (rear quarter panel) of the automobile vehicle.

U.S. Pat. No. 7,137,716 (2006) to Bogard relates to vehicle minors more particularly to a vehicle auxiliary rear view mirror assembly and method for eliminating blind spots in driver's rear-view vision”. This invention provides the perfect obstruction to a driver's view while backing up or driving on a highway. Putting this mirror assembly in this location is unsafe. This invention is not designed to operate on the posterior, lateral, external section (rear quarter panel) of the automobile vehicle, but rather inside the passenger compartment on the rear windshield.

U.S. patent application No. 200330107826 (2003) Shafrir “relates to mirrors and in particular to the use thereof for improving a motorist's vision when encountering blind spots”. FIGS. 14a and 14b show respectively initial and end positions of a dual mechanism operating according to the same principle for rotating a pair of mutual displaceable minors simultaneously”. The assembly shown in FIGS. 13a and 13b illustrates that the minors articulate simultaneously when actuated by a motor using a crank-slider linkage system where the slider is fixed and 131 translates, 134 and 132 translate and rotate. The assembly shown in 14a and 14b operates on the same principle as shown in FIGS. 14a and 14b.

U.S. patent application No. 20050052762 (2005) to Ejaz “relates to safety viewing device for motor vehicles. This device is prismatic and does not articulate or rotate at its apex. This invention is not designed to operate on the posterior, lateral, external section (rear quarter panel) of the automobile vehicle.

European patent application No. EP0235993 (1987) to Yang, Tai-Her Si-Hu TownDzan-Hwa (TW) relates to “relates to mirrors for vehicles, for example road vehicles”. This invention is prismatic and does not articulate or rotate at its apex, rather it rotates or articulates at its base shown in FIG. 2.

French patent No. FR2524851 (1980) to SCHABAD JEAN PIERRE [FR] “relates to a device for improving the visibility of motorists”. This invention is prismatic and does not articulate or rotate at its apex. This invention is not designed to operate on the posterior, lateral, external section (rear quarter panel) of the automobile vehicle. However, it is intended to be installed on the midline of the vehicle.

Danish patent No. DE3023208 (1982) to SCHEFFLER GUENTER DIPL ING assists drivers in maneuvering at intersections and eliminating blind spots. There are three figures for this invention. FIG. 1 illustrates the mirror assembly positioned near or at the midline of the automobile at the anterior and posterior of the automobile. This illustration shows that the minor functions at these locations with this assembly. FIG. 1 does not show that the mirror assembly articulates or rotates at it apex, but is fixed at a specific angle. FIG. 2 illustrates a minor positioned at the posterior, lateral, external section (rear quarter panel) of the vehicle, but the minor assembly does not have an apex, but is rather a flat, single mirror attached in some fashion to the vehicle; the minor must be removed and reaffixed to the automobile vehicle in order to change its angle. FIG. 3 is a convex mirror placed at or near the midline, anterior of the automobile vehicle.

Danish patent No. DE2600223 (1977) to SURLAN MIRKO DIPL ING assists drivers in maneuvering at intersections and eliminating blind spots. This invention is positioned at or near the midline of the vehicle to achieve its utility. This invention is not located at the posterior, lateral, external section (rear quarter panel) of the automobile. In addition, this invention does not articulate or rotate at its apex; it remains at a fixed, prescribed angle and is grudgingly adjustable by the user.

In conclusion, insofar as I am aware, no automobile minor whose purpose is to aid in safely reversing an automobile vehicle and its utility requires it to be located on the posterior, lateral, external section (rear quarter panel) of an automobile vehicle and articulates or rotates at its apex and has a reflective range of 0 to 180 degrees exists. The inventions stated above are either prismatic, not located at the rear quarter panel of an automobile vehicle, do not specify a method of attachment, do not articulate at the apex or a combination of one or more of these characteristics/limitations.

### SUMMARY

In accordance with the present invention a back-up mirror system 100 made up of: conventional rear-view mirror(s) 11 and 12 located on the driver door 13 and passenger door 14, in combination with a second mirror, the back-up mirror assemblies 17 and 16, located in a position on the rear quarter panel or posterior, lateral, external section of the driver and/or passenger side of an automobile vehicle, whose reflective surface is at an angle between 0 and 180 degrees, where the optimum angle is 45 degrees.

Together, the minors provide an automobile driver 15 with a back-up minor system allowing an alternative view of any nearby oncoming traffic in the lane(s) of cross-traffic. The detailed description and drawings more fully describe the features of this present invention and its several embodiments.

Advantages of the present invention are:
a. To provide a driver with an alternative view of the nearby traffic in lane(s) of cross-traffic passing behind the vehicle before backing up, especially when an adjacent view-blocking obstruction is present;
b. To allow a driver to see the alternative view without turning their head and eyes towards the rear window(s);
c. To provide this utility with a passive system (no power acquired from the automobile).
d. To provide this utility while the driver is in the driver's seat;
e. To provide this utility via an automotive aftermarket safety part which can effortlessly be mounted on the external driver and passenger sides of the automobile vehicle;
f. To have a mounting method which permits easy adjustment of the mirror angle to accommodate the relative locations of a driver's eyes, the vehicle's height, the shape of it's rear quarter panel(s), and the nearby traffic in cross-traffic lane(s) generally to a side of the rear of the vehicle, and the two minors, yet require no re-adjustment for successive uses by the same driver, and be easily re-adjustable for accommodating a different driver height for a different driver of the same vehicle;
g. To be relatively inexpensive yet effective in accomplishing the intended purposes;
h. To be readily incorporated into the design and manufacture of new passenger vehicles by the original equipment manufacturer;
i. To be simple in construction with relatively few parts while accomplishing the intended objectives.
j. To be relatively robust, with a relatively long functional life of service.
k. To not be limited to size scale, but each component of the back-up mirror assembly to be generally or approximately proportionate as shown in FIGS. 4 and 5.
l. To be constructed of relatively inexpensive, readily available materials currently found on the market.

Further objects and advantages of my invention will become apparent from a consideration of the drawings and detailed description.

### BRIEF DESCRIPTION OF DRAWINGS

FIG. 1 is a top view of the preferred embodiment of the back-up mirror system of the present invention, showing a first back-up minor 17 coupled to the rear quarter panel 19 on the driver's side of the vehicle and a second back-up mirror 16 coupled to the rear quarter panel 18 of the passenger's side of the vehicle.

FIG. 2 is a top view of back-up mirror of FIG. 1, showing a driver of a vehicle using the back-up minor system 100 to back out of a parking spot with cars parked on both sides of the driver.

FIG. 3 is a perspective view of the back-up mirror system of the present invention.

FIG. 4 contains exploded views of the backup minor assembly displaying all of the parts separately.

FIG. 4A is a front view of the back-up mirror assembly.

FIG. 4B is an exploded side view of the back-up minor assembly.

FIG. 4C is an exploded top view of the back-up minor assembly.

FIG. 4D is an exploded isometric view of the back-up minor assembly.

FIG. 5 contains assembled views of the backup mirror assembly displaying all of the parts separately.

FIG. 5A is a front view of the back-up mirror assembly.

FIG. 5B is an assembled side view of the back-up minor assembly.

FIG. 5C is an assembled top view of the back-up mirror assembly.

FIG. 5D is an assembled isometric view of the back-up minor assembly.

### DETAILED DESCRIPTION OF PREFERRED EMBODIMENTS

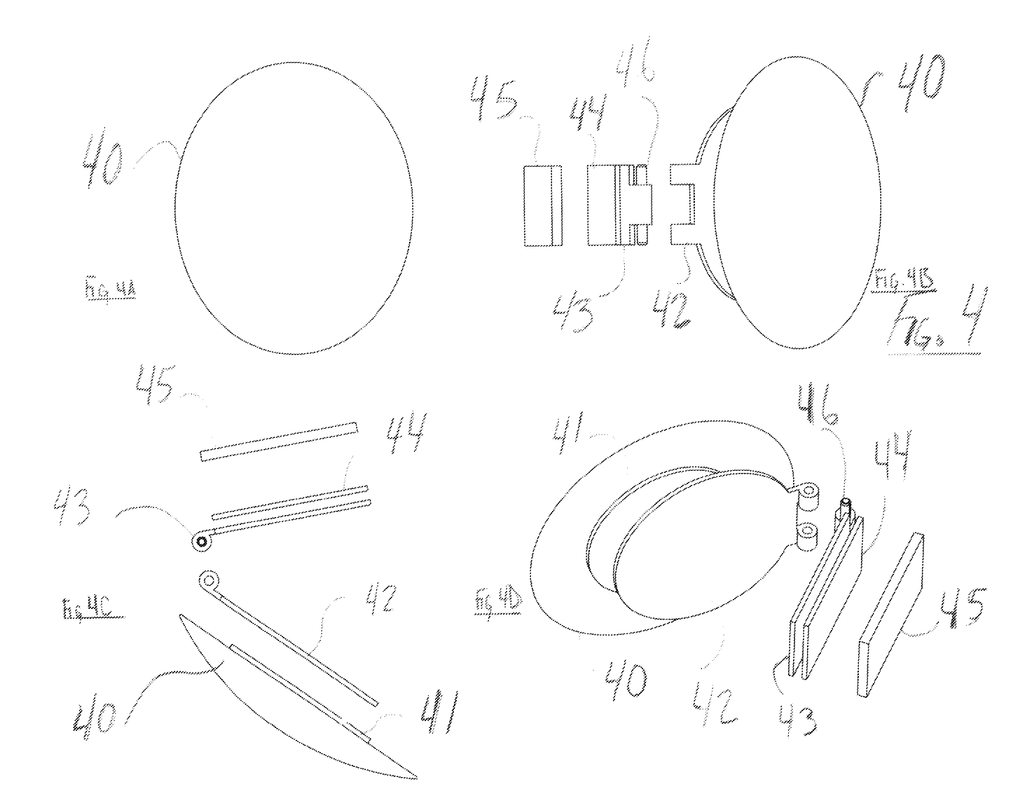

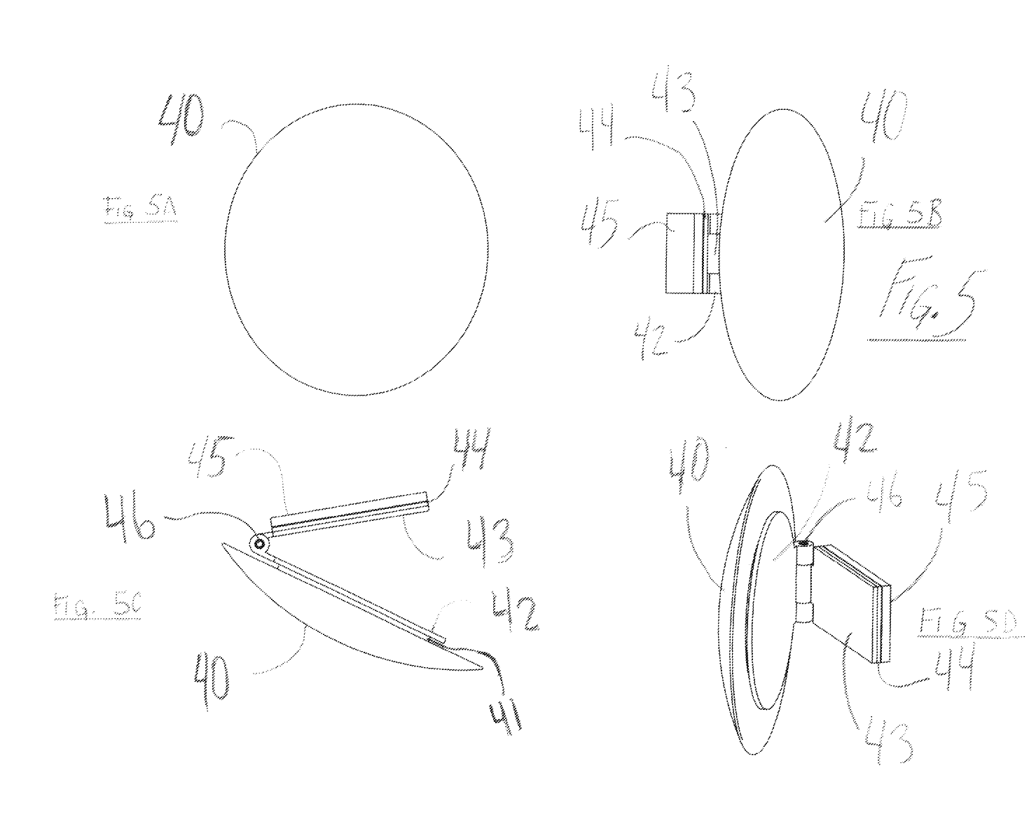

Referring now to FIGS. 4 and 5, the first back-up mirror assembly 17 comprised of a mirror 40 coupled to a mirror hinge 42 via minor adhesive or magnet 41. Mirror hinge 42 is coupled to quarter panel hinge 43 via hinge pin 46. Quarter panel hinge 43 is coupled to driver's side rear quarter panel 19 via quarter panel hinge adhesive 44 and/or magnet 46.

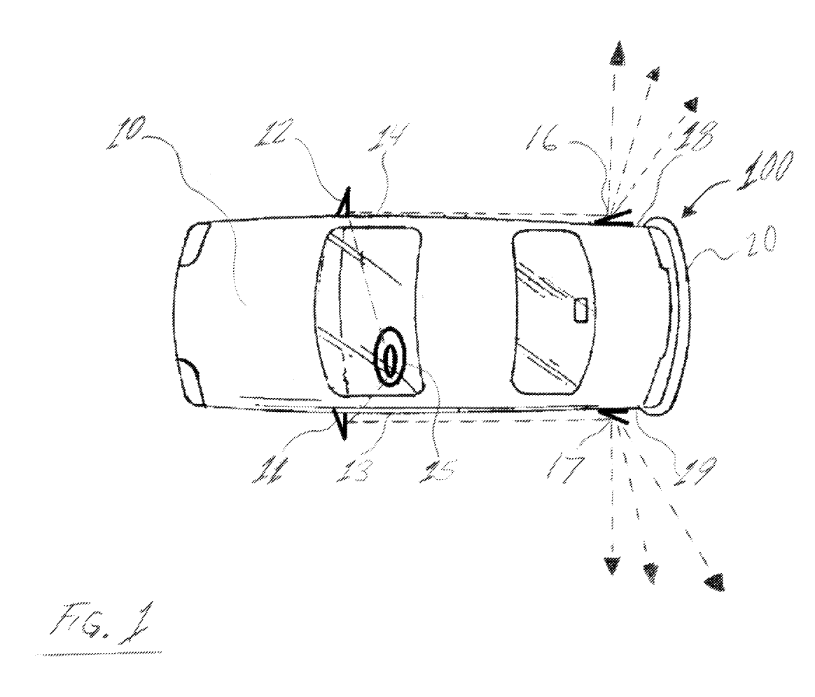

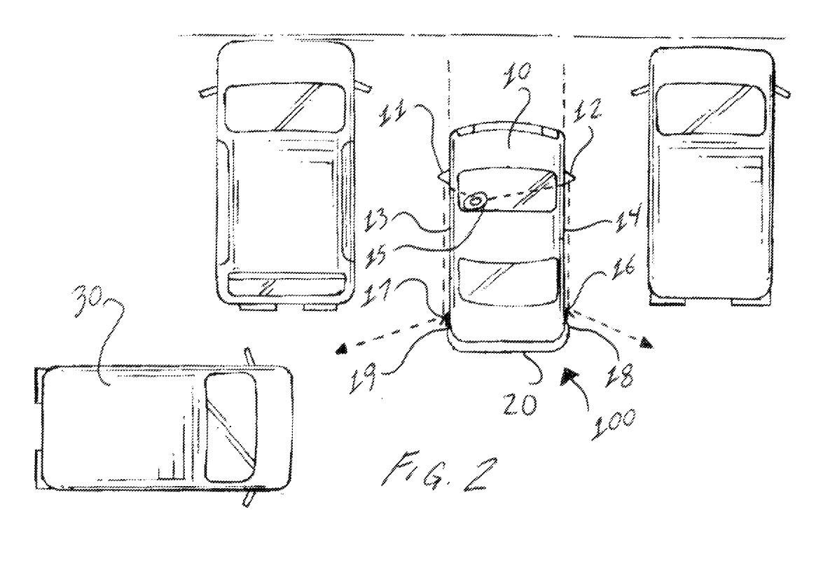

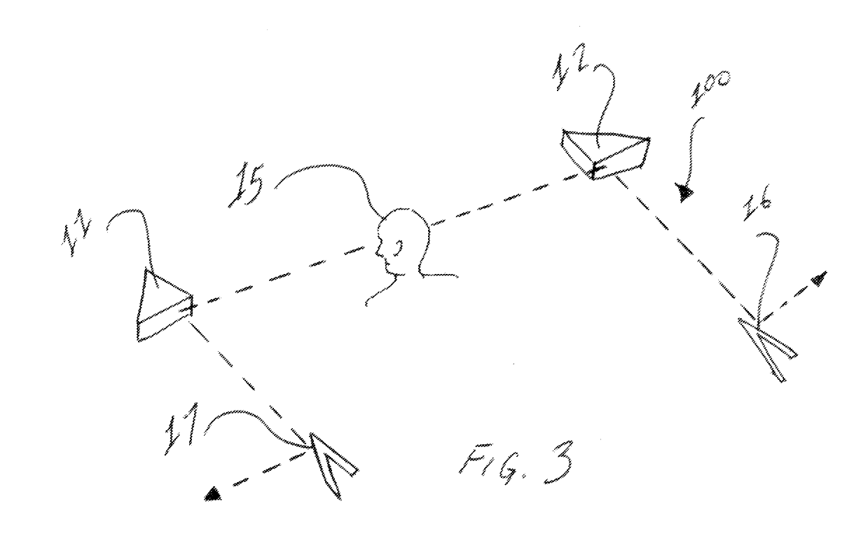

Referring now to FIGS. 1 and 2-3, the first back-up mirror assembly 17 is dimensioned to be positioned in a line of sight with a conventional rear-view minor 11. The first back-up mirror assembly 17 is dimensioned to allow driver 15 (shown in FIGS. 1-3) to view objects positioned lateral to the driver's side rear quarter panel 19 of a rear portion 20 of the vehicle 10 by looking at a reflection of the objects reflected from the first back-up minor assembly 17 to the conventional rear view minor 11 to the driver 15.

Referring now to FIGS. 4 and 5, the second back-up mirror assembly 16 comprised of a mirror 40 coupled to a minor hinge 42 via mirror adhesive or magnet 41. Mirror hinge 42 is coupled to quarter panel hinge 43 via hinge pin 46. Quarter panel hinge 43 is coupled to passenger's side rear quarter panel 18 via quarter panel hinge adhesive 44 and/or magnet 46.

Referring now to FIGS. 1 and 2-3, the back-up mirror system 100 further comprises a second back-up minor assembly 16. The second back-up mirror assembly 16 is essentially the same as the first back-up minor 17, except that the second back-up mirror assembly 16 is dimensioned to be positioned in the line of sight with a conventional rear-view mirror 12 on the passenger side of the vehicle 10. The second back-up minor assembly 16 is dimensioned to allow driver 15 (shown in FIGS. 1-3) to view objects positioned lateral to the passenger's side rear quarter panel 18 of a rear portion 20 of the vehicle 10 by looking at a reflection of the objects reflected from the second back-up mirror assembly 16 to the conventional rear-view minor 12 to the driver 15.

In the preferred embodiment, the first back-up mirror assembly 17 and second back-up minor assembly 16 are convex and have a substantially 40 inch radius of curvature, although it should be understood that the substantial benefit could be derived from an alternative configuration of the back-up mirror system 16 in which the first back-up minor assembly 17 and the second back-up minor assembly 16 are not convex or in which the radius of curvature deviates, even substantially from the preferred radius of curvature in either direction.

In the preferred embodiment, the mirror hinge 42 is of the first back-up mirror assembly 17 is rotatable relative to the quarter panel hinge 43 of the first back-up minor assembly 17. Also the minor hinge 42 is of the second back-up mirror assembly 16 is rotatable relative to the quarter panel hinge 43 of the second back-up minor assembly 16. In the preferred embodiment, the mirror hinge 42 is rotatable with respect the vertical axis of the hinge pin 46 in order for the user to be able to the adjust the angle of the between the minor hinge 42 and quarter panel hinge 43 to their unique requirements and use. However, it should be made clear that substantial benefit could be derived from and alternative configuration of the back-up mirror system 100 in which the first back-up minor assembly 17 and second back-up minor assembly 16 are not rotatable with respect to the vertical axis of the hinge pin 46 at all.

In one embodiment of the present invention, the quarter panel hinge 43, mirror hinge 42 and mirror 40 of the first back-up minor assembly 17 and the quarter panel hinge 43, minor hinge 42 and minor 40 of the second back-up minor assembly 16 are coupled to the rear quarter panels 19 and 18 respectively during a manufacturing stage of the vehicle 10.

### Statement of Operation

In operation the automobile operator 15 positions the first back-up mirror assembly 17 and the second back-up minor assembly 16 on the posterior, lateral, external section (rear quarter panel) such that the driver 15 of the automobile vehicle 10 is able to see the reflection of approaching car 30 or other objects from the left and/or right flanks of the automobile vehicle 10. The operator 15 has the option of adjusting the position of the back-up mirror assembly 17 and 16 to allow adequate reflection from the back-up mirror assembly 17 and 16 onto the conventional minor 11 and 12 and allow the automobile operator 15 to see approaching objects such as an approaching car 30 or other objects when obstacles such as adjacent cars 80 and 90 or other obstructions block the automobile operator's 15 peripheral view. The automobile operator 15 may manually or electronically adjust the angle of the mirror hinge 42 with respect to the vertical axis of the hinge pin 46 from 0 to 180 degrees to achieve the desired reflected image of approaching car 30 or other objects from the left and/or right flanks of the automobile vehicle 10. The back-up mirror assembly 17 and 16 is attached to the automobile vehicle 10 by magnet 46. The back-up mirror assembly 17 and 16 may be permanently attached using a very strong quarter panel hinge adhesive 44 material. The magnetic attachment of the back-up mirror assembly 17 and 16 allows the automobile operator 15 to remove the back-up minor assembly 17 and 16 and secure it in a safe place when not in use. The automobile operator 15 utilizes the back-up mirror 17 and 16 by looking in either the drivers or passenger side conventional rear-view mirrors 11 and 12 and observing the reflection of approaching objects 30 from the left and/or right flanks of the automobile vehicle 10 via the back-up minor assembly 17 and 16.

The following is a step-by-step process for using the back-up mirror assembly. These steps do not necessarily need to neither occur in this order or sequence nor encompass exclusively these steps, but this is an illustration to provide an example of how the back-up mirror assembly could be operated.
1. The automobile operator 15 places the back-up mirror assembly 17 and 16 on the automobile vehicle 10 in a spot the automobile operator 15 thinks is an optimum location on the rear quarter panel on the driver and passenger sides of the vehicle (See FIG. 1). The automobile operator 15 positions the mirror hinge 42 at a 45-degree angle as shown in FIG. 5 with respect to the vertical axis of the hinge pin 46 or to a suitable angle between 0 and 90 degrees with respect to the vertical axis of the hinge pin 46.
2. The automobile operator 15 gets into the automobile 10 and then adjusts the conventional rear-view mirrors 11 and 12 to acquire the reflected images of approaching objects from the left and right flanks of the automobile 10 via the back-up minor assembly 17 and 16.
3. Once the image of the back-up minor assembly 17 and 16 is acquired in the conventional rear-view mirror 11 and 12 the automobile operator 15 can now make the decision to engage the automobile 10 reverse gear and then maneuver the automobile safely.
4. Once the automobile driver 15 has safely maneuvered the automobile vehicle 10 safely, the automobile operator 15 has the option of removing the back-up minor assembly 17 and 16, if magnetically attached, or allowing the back-up minor assembly 17 and 16 to remain intact, if attached using a very strong adhesive. The driver also has the option of closing the back-up minor assembly 17 and 16, whether the back-up mirror assembly 17 and 16 is removed or remains intact.

More variations are possible:

The minor 40 could be a plain mirror or slightly convex (Radius>>>0), or be a combination of plain or convex of these or other minor types (hemispherical, cylindrical, asymmetric, non-spherical, etc.); the back-up minor assembly's mounting angles could be remotely readjusted via an actuated method similar to power-side-view mirrors found in some luxury vehicles; the surface area of the mirror(s) could be a variety of sizes, of rectangle, oval or other shapes; the mirror element can be constructed up of a variety of materials and/or substrates, which produce its reflective surface; the back-up mirror could be mounted on a remotely manipulated device which keeps the mirror folded away until the moment is needed, then the mirror is raised or opened for use, then retracted again, such as a sliding or pivoting method, with or without spring-loaded action; the back-up minor could be an automotive after-market accessory sold separately from the vehicle or be an original equipment feature included in a newly-manufactured automobile vehicle.

The scope of the present invention should not be limited by the embodiments and ramifications herein described, but encompass of any and all embodiments within the true spirit and scope of the following claims and their legal equivalents and such equivalent constructions which do not depart from the scope of the following claims.

### REFERENCE NUMERALS

10 VEHICLE
11 CONVENTIONAL REAR-VIEW MIRROR
12 CONVENTIONAL REAR-VIEW MIRROR
13 DRIVER DOOR
14 DRIVER DOOR
15 DRIVER
16 SECOND BACK-UP MIRROR ASSEMBLY
17 FIRST BACK-UP MIRROR ASSEMBLY
18 REAR QUARTER PANEL
19 REAR QUARTER PANEL
20 REAR PORTION
30 APPROACHING CAR
80 ADJACENT CAR
90 ADJACENT CAR
40 MIRROR
41 MIRROR ADHESIVE
42 MIRROR HINGE
43 QUARTER PANEL HINGE
44 QUARTER PANEL HINGE ADHESIVE
45 MAGNET
46 HINGE PIN
100 BACK-UP MIRROR SYSTEM

What is claimed and desired to be secured by Letter of Patent of the United States is:

1. A back-up mirror system to thwart accidents and injuries when a automobile operator 15 maneuvers an automobile vehicle in reverse into a lane or driveway of which objects such as other automobiles or pedestrians occupy or can occupy, comprising in combination:
a. a passenger vehicle, including a driver's side and a passenger side, said side include doors (front and rear), a rear bumper fixed at the rear end of said vehicle, rear quarter panels (driver and passenger sides), a passenger compartment, a driver's seat, a window at the rear of said passenger compartment, and
b. a conventional rear-view minor 11 and 12 consisting of a single optical element physically positioned with mounting means attached to the vehicle sides in a location generally on the front door driver and passenger sides, said rear view mirror's reflecting surface generally lying in a substantially vertical plane and which reflecting surface faces generally toward the aft of said vehicle lying in a plane substantially parallel with said rear bumper and substantially perpendicular to said rear quarter panel, and
a back-up mirror assembly 17 and 16 consisting of a minor 40, a minor adhesive or magnet 41, a minor hinge 42, a hinge pin 46, a quarter panel hinge 43, a quarter panel hinge adhesive 44, and a magnet 45, wherein the mirror hinge 42 is coupled to said quarter panel hinge 43 via said hinge pin 46, wherein the magnet 45 or quarter panel hinge adhesive 44 is physically positioned with magnetic and/or adhesive mounting means resting on said rear quarter panels in line of sight with said conventional rear-view minor 11 and 12 and said back-up mirror assembly capable of reflecting light emanating from areas parallel and perpendicular to said sides of the automobile vehicle, said back-up mirror assembly lying in plane capable of reflecting light emanating from a light source, said minor or back-up mirror assembly mirror generally lying at an angle ranging from 0 to 180 degrees, where in the back-up mirror assembly mirror hinge 42 articulates or rotates at its apex about a vertical axis, coupled via hinge pin, which is generally parallel to said vehicle side; all of whose relative physical locations and reflecting relationships from a physical structure wherein an image of a nearby oncoming cross-traffic object approaching from said passenger side or said driver's side and traveling in a lane of cross-traffic crossing behind said vehicle arrives at said driver's seat region via said conventional rear-view minor's image of said back-up minor assembly's image, whereby a driver sees a view of said nearby oncoming cross-traffic object, which information is needed at the moment of deciding the safety of driving said vehicle in reverse into said lane of cross-traffic, whereby a collision can be avoided, whereby the back-up mirror assembly does not substantially obstruct rear-views directly behind the vehicle.

2. A back-up mirror system to thwart accidents and injuries when a automobile operator 15 maneuvers an automobile vehicle in reverse into a lane or driveway of which objects such as other automobiles or pedestrians occupy or can occupy, comprising in combination:
a. a passenger vehicle, including a driver's side and a passenger side, said side include doors (front and rear), a rear bumper fixed at the rear end of said vehicle, rear quarter panels (driver and passenger sides), a passenger compartment, a driver's seat, a window at the rear of said passenger compartment, and
b. a conventional rear-view minor 11 and 12 consisting of a single optical element physically positioned with mounting means attached to the vehicle sides in a location generally on the front door driver and passenger sides, said rear view mirror's reflecting surface generally lying in a substantially vertical plane and which reflecting surface faces generally toward the aft of said vehicle lying in a plane substantially parallel with said rear bumper and substantially perpendicular to said rear quarter panel, and
a back-up mirror assembly 17 and 16 consisting of a minor 40, a minor adhesive or magnet 41, a minor hinge 42, a hinge pin 46, a quarter panel hinge 43, a quarter panel hinge adhesive 44, and a magnet 45, wherein the mirror hinge 42 is coupled to said quarter panel hinge 43 via said hinge pin 46, wherein the magnet 45 or quarter panel hinge adhesive 44 is physically positioned with magnetic and/or adhesive mounting means resting on said rear quarter panels in line of sight with said conventional rear-view minor 11 and 12 and said back-up mirror assembly capable of reflecting light emanating from areas parallel and perpendicular to said sides of the automobile vehicle, said back-up mirror assembly lying in plane capable of reflecting light emanating from a light source, said minor or back-up mirror assembly mirror generally lying at an angle ranging from 0 to 180 degrees, where in the back-up mirror assembly mirror hinge 42 articulates or rotates at its apex about a vertical axis, coupled via hinge pin, which is generally parallel to said vehicle side; all of whose relative physical locations and reflecting relationships from a physical structure wherein an image of a nearby oncoming cross-traffic object approaching from said passenger side or said driver's side and traveling in a lane of cross-traffic crossing behind said vehicle arrives at said driver's seat region via said conventional rear-view minor's image of said back-up minor assembly's image, whereby a driver sees a view of said nearby oncoming cross-traffic object, which information is needed at the moment of deciding the safety of driving said vehicle in reverse into said lane of cross-traffic, whereby a collision can be avoided, whereby the back-up mirror assembly does not substantially obstruct rear-views directly behind the vehicle.
